(19) United States
(12) Patent Application Publication
(10) Pub. No.: US 2011/0049447 A1
(43) Pub. Date: Mar. 3, 2011

(54) SAFETY VEHICLE RAMP AND METHOD

(76) Inventor: William David Haren, Davidson, NC (US)

(21) Appl. No.: 12/730,489

(22) Filed: Mar. 24, 2010

Related U.S. Application Data
(60) Provisional application No. 61/275,329, filed on Aug. 28, 2009.

(51) Int. Cl. B66F 7/24

(52) U.S. Cl. 254/88

(57) ABSTRACT

A vehicular safety ramp apparatus has a ramp including an inclined ramp surface for progressively elevating a front wheel of a vehicle above a surface on which the ramp is positioned. An elongate web is carried by the ramp and extends outwardly from the ramp in longitudinal alignment with the ramp and having a length at least as long as a distance from a lowermost end of the ramp surface to a rear wheel positioned rearwardly of the front wheel to be elevated. The web is adapted for being placed under the rear wheel whereby the weight of the rear wheel locks the ramp in a fixed position as the front wheel is progressively elevated and lowered along the ramp surface.

### CROSS REFERENCE TO RELATED APPLICATIONS

This non-provisional patent application claims the benefit of priority and incorporates herein the contents of U.S. provisional patent application 61/275,329 filed on Aug. 28, 2009, entitled “Sure Strap—Car Ramp.”

### TECHNICAL FIELD AND BACKGROUND OF THE INVENTION

This invention relates generally to a ramp apparatus and method for raising and lowering a vehicle, and more particularly to a ramp apparatus locked into an immovable safety position when in use.

A typical ramp has an inclined ramp surface leading to a raised horizontal portion upon which the wheel of a vehicle is positioned when raised. Such ramps are typically used in pairs and are used to raise, for example, the front end of a vehicle as the engine of the vehicle is serviced, and are often used by individuals servicing their vehicles at their homes and such.

Inconveniences and accidents can arise when a conventional stand moves as a vehicle begins to mount the ramp. As the vehicle wheels contact a pair of positioned stands, one or both ramps may move away from the vehicle instead of raising the wheels. When this occurs, one or both ramps are moved forward from their desired positions. Even if they are placed on a long surface such as a driveway, any movement of either ramp can cause lateral alignment of the two ramps to be lost, and can cause the final position of the raised vehicle to be changed from a desired location. A vehicle may ultimately be raised on only one side, may drive off of one of the ramps, and may be damaged or may cause damage to a garage door or other nearby structures or items. Conversely, when lowering the vehicle the ramps tend to kick out forward when the vehicle wheels interfaces with the concrete floor or driveway. This can cause damage to nearby structures or people.

Therefore, there exists a need for improved ramps and methods for raising and lowering vehicles without movement of the ramps.

### BRIEF SUMMARY OF THE INVENTION

Therefore it is an object of the present invention to provide ramps for safely raising and lowering a vehicle while the ramps are maintained in fixed positions by the weight of the vehicle.

These and other aspects of the invention are achieved by providing a vehicular safety ramp apparatus having a ramp including an inclined ramp surface for progressively elevating a front wheel of a vehicle above a surface on which the ramp is positioned. An elongate web is carried by the ramp and extends outwardly from the ramp in longitudinal alignment with the ramp and having a length at least as long as a distance from a lowermost end of the ramp surface to a rear wheel positioned rearwardly of the front wheel to be elevated. The web is adapted for being placed under the rear wheel whereby the weight of the rear wheel locks the ramp in a fixed position as the front wheel is progressively elevated and lowered along the ramp surface.

According to another aspect of the invention, the web is a woven synthetic fabric tape.

According to another aspect of the invention, a hinge having a first hinge leaf is mounted to the ramp and a second hinge leaf is pivotally mounted to the first hinge, with the web attached thereto, by a removable pin for removal and storage of the strap/web.

According to another aspect of the invention, a reel is mounted to the ramp under the inclined ramp surface, and a hand crank is attached to the reel for rotating the reel and winding the web into a storage position when not in use.

According to another aspect of the invention, a vehicular safety ramp apparatus includes first and second ramps, each having a pair of spaced-apart side walls and an inclined ramp surface for progressively elevating and lowering first and second front wheels of a vehicle above a surface on which the ramps are positioned. An elongate web is carried by a lowermost end of each of the ramp surfaces and extendable outwardly from the first and second ramps in longitudinal alignment with the respective first and second ramps. Each web has a length at least as long as a distance from the lowermost ends of the ramp surfaces to respective first and second rear wheels of the vehicle. When the rear wheels are rolled onto the webs, the first and second ramps are locked into a fixed position as the front wheels are progressively elevated and lowered along the ramp surface.

According to another aspect of the invention, the webs are preferably woven synthetic fabric tapes.

According to another aspect of the invention, first and second reels are mounted under respective ones of the first and second inclined ramp surfaces, and first and second hand cranks attached to respective reels for rotating the reels and winding the webs into a storage position under the respective first and second ramps when not in use.

According to another aspect of the invention, a method of locking a pair of vehicle ramps into an immovable safety position when in use includes the steps of providing first and second ramps for being positioned on a supporting surface. Each of the first and second ramps has side walls and an inclined ramp surface for progressively elevating first and second front wheels of a vehicle having a pair of front and aligned rear wheels. First and second elongate webs are carried by a lowermost end of respective ramp surfaces, the webs having a length at least as long as a distance from the lowermost end of the ramp surfaces to the respective aligned rear wheels of the front wheels to be elevated. The method also includes positioning the first and second ramps in laterally spaced-apart position to receive the front wheels of the vehicle, extending the webs outwardly along the supporting surface from the first and second ramps in longitudinal alignment with the ramps, and moving a vehicle whereby the front and rear wheels roll onto the respective first and second webs. The weight of the rear wheels fixes the web in a stationary position and locks the attached first and second ramps in a fixed position as the front wheels are progressively elevated and lowered along the ramp surface.

According to another aspect of the invention, a method of locking a pair of vehicle ramps into an immovable safety position when in use, includes the steps of providing first and second ramps for being positioned on a supporting surface. Each of the ramps have an inclined ramp surface for progressively elevating and lowering first and second front wheels of a vehicle having a pair of front and aligned rear wheels. The first and second elongate webs are carried by a lowermost end of respective ramp surfaces, and the webs have a length at least as long as a distance from the lowermost end of the ramp surfaces to the respective aligned rear wheels of the front wheels to be elevated. The method includes the steps of positioning the first and second ramps in laterally spaced-apart position to receive the front wheels of the vehicle, extending the webs outwardly along the supporting surface from the first and second ramps in longitudinal alignment with the ramps, and moving the vehicle whereby as the front and rear wheels roll onto the respective first and second webs of the vehicle, the weight of the rear wheels fixes the web in a stationary position and locks the attached first and second ramps in a fixed position as the front wheels are progressively elevated and lowered along the ramp surface.

### BRIEF DESCRIPTION OF THE DRAWINGS

The subject matter that is regarded as the invention may be best understood by reference to the following description taken in conjunction with the accompanying drawing figures in which:

FIG. 1 is a perspective view of a pair of ramps according to one embodiment of the present invention;

FIGS. 2A-2C are environmental views of the ramps of FIG. 1 being approached, positionally fixed, and mounted by a vehicle; and

FIG. 3 is a perspective view of another embodiment of a ramp according to another embodiment of the invention.

### DETAILED DESCRIPTION OF THE INVENTION

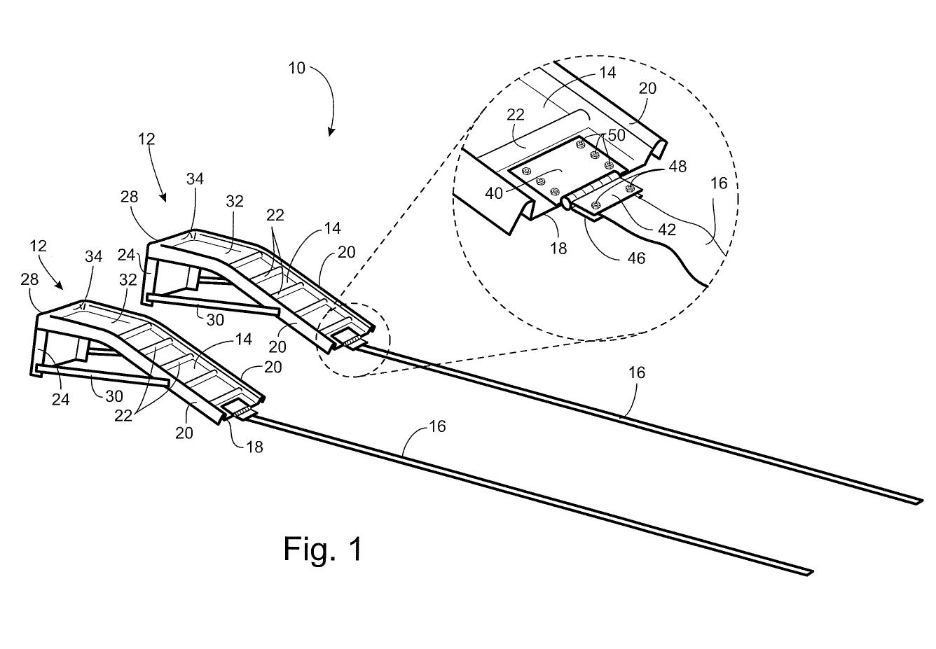

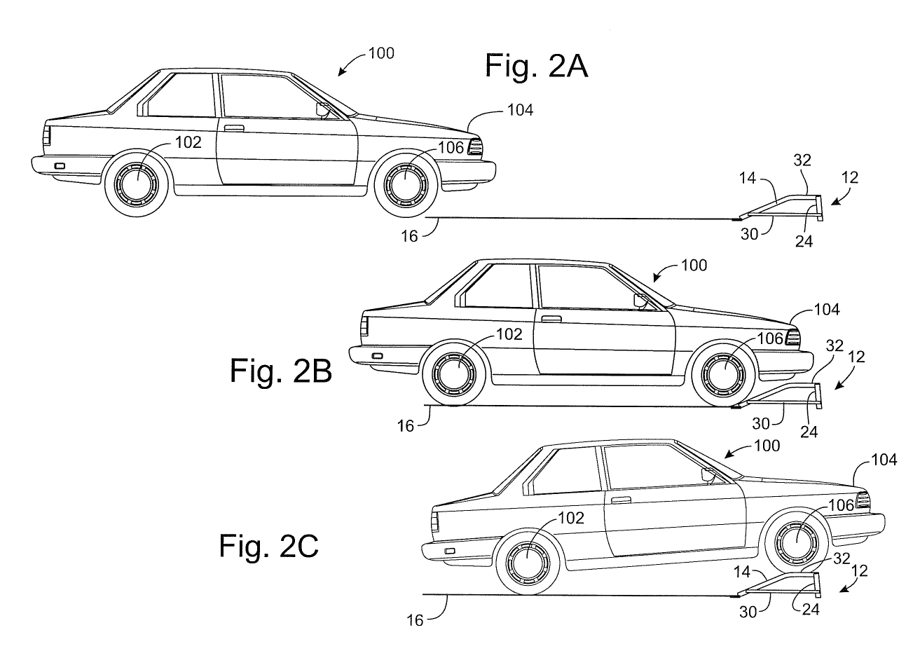

Referring to the drawings wherein identical reference numerals denote the same elements throughout the various views, FIGS. 1 and 2 illustrate a vehicular safety ramp apparatus 10 according to one embodiment of the present invention. The apparatus includes a pair of ramps 12, each of which includes an inclined ramp surface 14 and an elongate web 16 attached to the lowest end 18 of the ramp surface 14. The ramps 12 are substantially similar and so portions of these descriptions refer to a single ramp 12 for brevity.

Spaced apart sidewalls 20 extend along the lateral sides of the ramp surface 14 to provide rigidity to the ramp 12 and to guide the wheels of a vehicle. Raised laterally extending ribs 22 are spaced along the ramp surface 14 to facilitate wheel traction and to provide rigidity to the ramp 12. Generally vertical legs 24 support the ramp 12 at the upper end 28 opposite the lowest end 18. Generally horizontal members 30 add strength to prevent collapse of the ramp 12 by fixing the legs 24 in their positions relative to the ramp surface 14. The sidewalls 20 are continuous around the top portion 32 of the ramp 12, forming an end wall 34 that helps to prevent a vehicle from driving onto and over the ramp 12. The ramp 12 is constructed of suitably durable and strong material such as steel, aluminum, other metals, compsite plastic/fiberglass, or other structurally sound materials. The ramp 12 may be constructed as one integrally formed piece of material or may be assembled from parts joined together by welding, fasteners such as threaded connectors and rivets, or other joining elements.

The web 16 is constructed of woven synthetic fabric tape in one example. The web 16 can be constructed of a variety of materials that have suitable tensile strength and sufficient durability against wear so as to permit many uses during which the webs are driven upon as shown in FIGS. 2A-2C. As shown in FIG. 2B, each web 16 is at least as long as the distance between the wheels of the vehicle that the ramp 12 is positioned to raise. As shown in FIG. 1, the webs 16 are extended in longitudinal alignment with the ramps 12 in preparation for use in raising an approaching vehicle 100 (FIG. 2A).

As shown in the enlarged portion of FIG. 1, the web 16 is pivotally mounted to the lowest end 18 of the ramp surface 14. A first hinge leaf 40 is mounted to the ramp 12 and a second hinge leaf 42 is attached to the web 16. The web 16 is captured between the second hinge leaf 42 and a backing plate 46, which are connected together on opposite sides of the web 16 by fasteners 48. The second hinge leaf 42 is pivotally mounted to the first hinge leaf 40, and the web 16 is thereby pivotally mounted to the lowest end 18 of the ramp surface 14 by way of the first and second hinge leaves 40 and 42. The first hinge leaf 40 and the ramp 12 are shown in the enlarged portion of FIG. 1 as joined together by threaded fasteners 50 as an example. They may also be joined together by other types of fasteners such as rivets, welding, or other joining elements.

FIGS. 2A-2C are environmental views of the ramps of FIG. 1 being approached, positionally fixed as the wheels of the vehicle 100 drive upon the webs 16, and mounted by the vehicle 100. In FIG. 2A, the vehicle 100 approaches the ramp 12 and web 16. In FIG. 2B, the vehicle 100 is positioned upon the web 16. This fixes the position of the ramp 12 as the weight of the vehicle 100 bears upon the web 16, and the web 16 is thereby trapped between the wheels of the vehicle 10 and the surface upon which the web 16 and ramp 12 are positioned. As the vehicle 100 is forcibly driven forward by its back wheels 102, the forward end 104 of the vehicle 100 is progressively raised until the front wheels 106 are positioned on the top portion 32 of the ramp 12. During the raising of the front wheels 106 along the ramp surface 14, any tendency of the ramp 12 to slip forward and away from the vehicle 10 is prevented by the web 16, which is held in its position by the back wheels 102 of the vehicle 100 even as the back wheels 102 rotate and force the vehicle 100 forward and the front wheels 106 are forced up the ramps 12. The vehicle can be safely lowered by reversing the steps shown in FIGS. 2A-2C.

These descriptions refer to “front wheels” and “back wheels” with regard to those wheels of a vehicle that are closest to and furthest from the ramps 12 respectively. Thus, “front wheels” refer to those wheels that mount the ramps 12 when a vehicle approaches the ramps in a fashion appreciated by the driver as driving forward. Similarly, “front wheels” refer to those wheels that mount the ramps when a vehicle approaches the ramps 12 in an opposite fashion appreciated by the driver as reversing. Thus, in any fashion by which a vehicle approaches, the “front wheels” mount the ramps and the “back wheels” bear weight upon the webs 16.

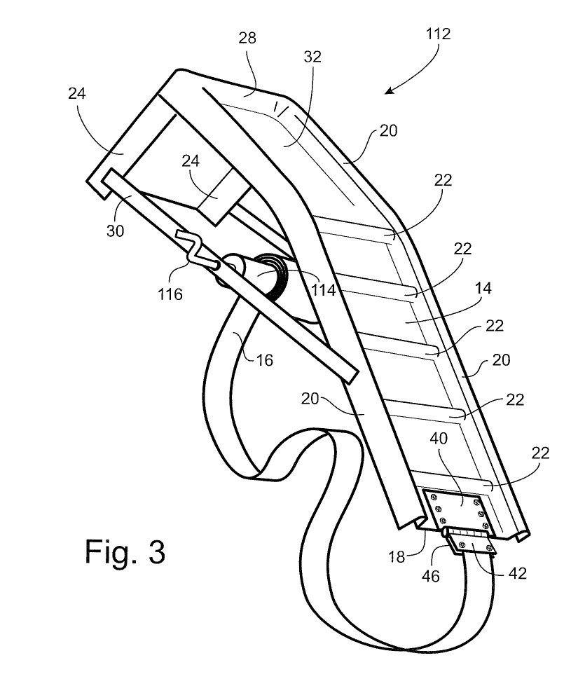

The ramp 112 shown in FIG. 3 includes an additional feature over the ramp 12 of FIG. 1, but is otherwise substantially the same. The ramp 112 includes a reel 114 mounted under the inclined ramp surface 14 for winding the web 16 into a storage position as shown when not in use. A hand crank 116 is attached to the reel 114 for rotating the reel 114 and winding the web 16 into the storage position as shown.

While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A vehicular safety ramp apparatus, comprising:
(a) a ramp including an inclined ramp surface for progressively elevating a front wheel of a vehicle above a surface on which the ramp is positioned; and
(b) an elongate web carried by the ramp and extendable outwardly from the ramp in longitudinal alignment with the ramp and having a length at least as long as a distance from a lowermost end of the ramp surface to a rear wheel positioned rearwardly of the front wheel to be elevated, the web adapted for being placed under the rear wheel whereby the weight of the rear wheel locks the ramp in a fixed position as the front wheel is progressively elevated and lowered along the ramp surface.

2. A vehicular safety ramp apparatus, according to claim 1, wherein the web comprises a woven synthetic fabric tape.

3. A vehicular safety ramp apparatus, according to claim 1, and including a hinge comprising a first hinge leaf mounted to the ramp and a second hinge leaf pivotally mounted to the first hinge leaf and having the web attached thereto.

4. A vehicular safety ramp apparatus, according to claim 1, and including a reel mounted to the ramp under the inclined ramp surface, a hand crank attached to the reel for rotating the reel and winding the web into a storage position when not in use.

5. A vehicular safety ramp apparatus, comprising:
(a) first and second ramps, each having a pair of spaced-apart side walls and an inclined ramp surface for progressively elevating and lowering first and second front wheels of a vehicle above a surface on which the ramps are positioned; and
(b) an elongate web carried by a lowermost end of each of the ramp surfaces and extendable outwardly from the first and second ramps in longitudinal alignment with the respective first and second ramps, each web having a length at least as long as a distance from lowermost ends of the ramp surfaces to respective first and second rear wheels of the vehicle whereby, when the rear wheels are rolled onto the webs, the first and second ramps are locked into a fixed position as the front wheels are progressively elevated and lowered along the ramp surface.

6. A vehicular safety ramp apparatus, according to claim 5, wherein the webs comprise woven synthetic fabric tapes.

7. A vehicular safety ramp apparatus, according to claim 5, and including a hinge comprising first and second hinge leaves mounted to respective first and second ramps and a second hinge leaves pivotally mounted to respective first and second hinge leaves and having the respective first and second webs attached thereto.

8. A vehicular safety ramp apparatus, according to claim 5, and including first and second reels mounted under respective ones of the first and second inclined ramp surfaces, and first and second hand cranks attached to respective reels for rotating the reels and winding the webs into a storage position under the respective first and second ramps when not in use.

9. A method of locking a pair of vehicle ramps into an immovable safety position when in use, comprising the steps of:
(a) providing:
(i) first and second ramps for being positioned on a supporting surface; each of the first and second ramps having side walls and an inclined ramp surface for progressively elevating first and second front wheels of a vehicle having a pair of front and aligned rear wheels;
(ii) first and second elongate webs carried by a lowermost end of respective ramp surfaces, the webs having a length at least as long as a distance from the lowermost end of the ramp surfaces to the respective aligned rear wheels of the front wheels to be elevated;
(b) positioning the first and second ramps in laterally spaced-apart position to receive the front wheels of the vehicle;
(c) extending the webs outwardly along the supporting surface from the first and second ramps in longitudinal alignment with the ramps; and
(d) moving a vehicle whereby the front and rear wheels roll onto the respective first and second webs, the weight of the rear wheels fixing the web in a stationary position and locking the attached first and second ramps in a fixed position as the front wheels are progressively elevated and lowered along the ramp surface.

10. A method of locking a pair of vehicle ramps into an immovable safety position when in use, comprising the steps of:
(a) providing:
(i) first and second ramps for being positioned on a supporting surface; each of the ramps having an inclined ramp surface for progressively elevating and lowering first and second front wheels of a vehicle having a pair of front and aligned rear wheels;
(ii) first and second elongate webs carried by a lowermost end of respective ramp surfaces, the webs having a length at least as long as a distance from the lowermost end of the ramp surfaces to the respective aligned rear wheels of the front wheels to be elevated;
(b) positioning the first and second ramps in laterally spaced-apart position to receive the front wheels of the vehicle;
(c) extending the webs outwardly along the supporting surface from the first and second ramps in longitudinal alignment with the ramps; and
(d) moving the vehicle whereby as the front and rear wheels roll onto the respective first and second webs of the vehicle, the weight of the rear wheels fixes the web in a stationary position and locks the attached first and second ramps in a fixed position as the front wheels are progressively elevated and lowered along the ramp surface.
